(19) United States
(12) Patent Application Publication
(10) Pub. No.: US 2025/0061525 A1
(43) Pub. Date: Feb. 20, 2025

(54) METHOD FOR PROVIDING FOOD ORDERING SERVICES VIA ARTIFICIAL INTELLIGENCE VISUAL CASHIER

(71) Applicant: BitHuman Inc

(72) Inventors: Steve Gu, Lafayette, CA (US); Yun Fu, Newton, MA (US)

(73) Assignee: BitHuman Inc, (omitted)

(21) Appl. No.: 18/235,557

(22) Filed: Aug. 18, 2023

(51) Int. Cl. G06Q 50/12; G06F 3/01; G06Q 30/0601; G06T 11/00; G06V 40/16

(52) U.S. Cl. CPC G06Q 50/12; G06F 3/012; G06F 3/013; G06Q 30/0631; G06Q 30/0635; G06T 11/00; G06V 40/168; G06V 40/172; G10L 17/22

(57) ABSTRACT

Embodiments of the present disclosure may include a method for providing food ordering services via a virtual cashier with artificial intelligence within a restaurant.

### BACKGROUND OF THE INVENTION

Embodiments of a method for providing food ordering services via a virtual cashier with artificial intelligence within a restaurant.

### BRIEF SUMMARY

Embodiments of the present disclosure may include a method for providing food ordering services via a virtual cashier with artificial intelligence within a restaurant, the method including detecting, by one or more processors, a food ordering request from a user in the restaurant. In some embodiments, an artificial intelligence engine may be coupled to one or more processors and a server.

In some embodiments, the artificial intelligence engine may be trained by human experts in the field. In some embodiments, the virtual cashier may be configured to be displayed in LED/OLED displays, Android/iOS tablets, Laptops/PCs, smartphones, or VR/AR goggles. In some embodiments, a set of multi-layer info panels coupled to one or more processors may be configured to overlay graphics on top of the virtual cashier.

In some embodiments, the virtual cashier may be configured to be displayed with an appearance of a real human or a humanoid or a cartoon character. In some embodiments, the virtual cashier's gender, age and ethnicity may be determined by the artificial Intelligence's analysis on input from the user. In some embodiments, the virtual cashier may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

In some embodiments, the one or more processors may put the user in a waiting list if the restaurant may be full and will notify the user when the table may be ready and will estimate waiting time and communicate with customers. Embodiments may also include detecting and tracking the user's face, eye, and pose by a set of outward-facing cameras coupled to the one or more processors.

In some embodiments, a set of touch screens coupled to the one or more processors may be configured to allow the user to interact with the virtual cashier by hand. Embodiments may also include detecting the user's voice by a set of microphones coupled to the one or more processors. In some embodiments, the set of microphones may be connected to loudspeakers.

In some embodiments, the set of microphones may be enabled to be beamforming. In some embodiments, pictures or voices of the user may be configured to be uploaded and processed either on a cloud server or in local or personal devices to analyze and create the virtual cashier. In some embodiments, the virtual cashier may be configured to be created based on the appearance of a real human character, a popular cartoon character.

In some embodiments, the virtual cashier may be related to a personality shown in the advertisement of the restaurant. Embodiments may also include analyzing the user's profile from audio-visual information gathered by the set of outward-facing cameras and the set of microphones. In some embodiments, the user's profile includes the user's audio and facial characteristics.

Embodiments may also include selecting the user's profile based on matching audio and facial characteristics from a set of profiles in a customer database on the server. In some embodiments, the user's profile may include information on prior food ordering habits, food preferences, and possible food allergies. Embodiments may also include guiding and suggesting a set of menu items through conversation between the virtual cashier and the user.

In some embodiments, the conversation may be based on the user's profile and analysis of the artificial intelligence engine. Embodiments may also include providing options to help make an ordering choice through the conversation. Embodiments may also include receiving a food ordering input from the user. In some embodiments, the food ordering input may include any food special requests from the user. Embodiments may also include transmitting the food ordering input to the kitchen of the restaurant. In some embodiments, the food special requests include the preferred degree of sweetness of the drink. In some embodiments, the food ordering input may be incorporated into the user's profile by the artificial intelligence engine.

Embodiments of the present disclosure may also include a method for providing food ordering services via a virtual cashier with artificial intelligence within a restaurant, the method including detecting, by one or more processors, a food ordering request from a user in the restaurant. In some embodiments, an artificial intelligence engine may be coupled to the one or more processors and a server.

In some embodiments, the artificial intelligence engine may be trained by human experts in the field. In some embodiments, the virtual cashier may be configured to be displayed in LED/OLED displays, Android/iOS tablets, Laptops/PCs, smartphones or VR/AR goggles. In some embodiments, a set of multi-layer info panels coupled to the one or more processors may be configured to overlay graphics on top of the virtual cashier.

In some embodiments, the virtual cashier may be configured to be displayed with an appearance of a real human or a humanoid or a cartoon character. In some embodiments, the virtual cashier's gender, age and ethnicity may be determined by the artificial Intelligence's analysis on input from the user. In some embodiments, the virtual cashier may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include detecting and tracking the user's face, eye, and pose by a set of outward-facing cameras coupled to the one or more processors. In some embodiments, a set of touch screens coupled to the one or more processors may be configured to allow the user to interact with the virtual cashier by hand. Embodiments may also include detecting the user's voice by a set of microphones coupled to the one or more processors.

In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the virtual cashier.

In some embodiments, the virtual cashier may be configured to be created based on the appearance of a real human character, a popular cartoon character. In some embodiments, the virtual cashier may be related to a personality shown in the advertisement of the restaurant. Embodiments may also include analyzing the user's profile from audio-visual information gathered by the set of outward-facing cameras and the set of microphones.

In some embodiments, the user's profile includes the user's audio and facial characteristics. Embodiments may also include selecting the user's profile based on matching audio and facial characteristics from a set of profiles in a customer database on the server. In some embodiments, the user's profile may include information on prior food ordering habits, food preferences, and possible food allergies.

Embodiments may also include guiding and suggesting a set of menu items through conversation between the virtual cashier and the user. In some embodiments, the conversation may be based on the user's profile and analysis of the artificial intelligence engine. Embodiments may also include providing options to help make an ordering choice through the conversation.

Embodiments may also include receiving a food ordering input from the user. In some embodiments, the food ordering input may include any food special requests from the user. Embodiments may also include transmitting the food ordering input to the kitchen of the restaurant. Embodiments may also include calculating total cost of the food ordering from the food ordering input from the user.

Embodiments may also include subtracting the special discount from the total cost of the food ordering. Embodiments may also include receiving payment from the user via the set of touch screens. In some embodiments, the user can choose payment methods for the payment. In some embodiments, the artificial intelligence engine may be configured to use face recognition, and other personal identification means for payment. In some embodiments, the artificial intelligence engine may be also configured to identify the user through question and answer. Embodiments may also include providing receipt of the payment to the user. In some embodiments, the food special requests include the preferred degree of sweetness of the drink. In some embodiments, the food ordering input may be incorporated into the user's profile by the artificial intelligence engine.

Embodiments of the present disclosure may also include a method for providing food ordering services via a virtual cashier with artificial intelligence within a restaurant, the method including detecting, by one or more processors, food ordering requests from a group of users in the restaurant. In some embodiments, an artificial intelligence engine may be coupled to the one or more processors and a server.

In some embodiments, the artificial intelligence engine may be trained by human experts in the field. In some embodiments, the virtual cashier may be configured to be displayed in LED/OLED displays, Android/iOS tablets, Laptops/PCs, or smartphones, or VR/AR goggles. In some embodiments, a set of multi-layer info panels coupled to the one or more processors may be configured to overlay graphics on top of the virtual cashier.

In some embodiments, the virtual cashier may be configured to be displayed with an appearance of a real human or a humanoid or a cartoon character. In some embodiments, the virtual cashier's gender, age and ethnicity may be determined by the artificial Intelligence's analysis of input from the group of users. In some embodiments, the virtual cashier may be configured to be displayed in full-body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include detecting and tracking the group of users'faces, eyes, and pose by a set of outward-facing cameras coupled to the one or more processors. In some embodiments, a set of touch screens coupled to the one or more processors may be configured to allow the group of users to interact with the virtual cashier by hand. Embodiments may also include detecting the group of users'voice by a set of microphones coupled to the one or more processors.

In some embodiments, the set of microphones may be connected to loudspeakers. In some embodiments, the set of microphones may be enabled to be beamforming. In some embodiments, pictures or voices of the group of users may be configured to be uploaded and processed either on a cloud server or in local or personal devices to analyze and create the virtual cashier.

In some embodiments, the virtual cashier may be configured to be created based on the appearance of a real human character, a popular cartoon character. In some embodiments, the virtual cashier may be related to a personality shown in the advertisement of the restaurant. Embodiments may also include analyzing the group of users'profiles from audio-visual information gathered by the set of outward-facing cameras and the set of microphones.

In some embodiments, the group of users'profiles includes the group of users'audio and facial characteristics. Embodiments may also include selecting the group of users'profile based on matching audio and facial characteristics from a set of profiles in a customer database on the server. In some embodiments, the group of users'profiles may include information on prior food ordering habits, food preferences, and possible food allergies.

Embodiments may also include guiding and suggesting a set of menu items through conversation between the virtual cashier and the group of users. In some embodiments, the conversation may be based on the group of users'profile and analysis of the artificial intelligence engine. In some embodiments, the artificial intelligence engine may analyze the social settings of the group of users and provide balanced recommendations and suggestions crossing different profiles and personal preference and restrictions.

Embodiments may also include providing options to help make an ordering choice through the conversation. Embodiments may also include receiving food ordering inputs from the group of users. In some embodiments, the food ordering input may include any food special requests from the group of users. Embodiments may also include transmitting the food ordering inputs to the kitchen of the restaurant.

Embodiments may also include calculating total cost of the food ordering from the food ordering input from the group of users. Embodiments may also include subtracting the special discount from the total cost of the food ordering. Embodiments may also include receiving payment from the group of users via the set of touch screens.

In some embodiments, the group of users can choose payment methods for the payment. In some embodiments, the artificial intelligence engine may be configured to use face recognition, and other personal identification means for payment. In some embodiments, the artificial intelligence engine may be also configured to identify the group of users through question and answer. Embodiments may also include providing a receipt of the payment to the group of users.

### BRIEF DESCRIPTION OF THE FIGURES

FIG. 1A is a flowchart illustrating a method for providing food ordering services via a visual cashier with artificial intelligence, according to some embodiments of the present disclosure.

FIG. 1B is a flowchart extending from FIG. 1A and further illustrating the method for providing food ordering services via a visual cashier with artificial intelligence, according to some embodiments of the present disclosure.

FIG. 2A is a flowchart illustrating a method for providing food ordering services via a visual cashier with artificial intelligence, according to some embodiments of the present disclosure.

FIG. 2B is a flowchart extending from FIG. 2A and further illustrating the method for providing food ordering services via a visual cashier with artificial intelligence, according to some embodiments of the present disclosure.

FIG. 3A is a flowchart illustrating a method for providing food ordering services via a visual cashier with artificial intelligence, according to some embodiments of the present disclosure.

FIG. 3B is a flowchart extending from FIG. 3A and further illustrating the method for providing food ordering services via a visual cashier with artificial intelligence, according to some embodiments of the present disclosure.

FIG. 4 is a diagram showing an example of a method of providing food ordering services via a visual cashier with artificial intelligence

FIG. 5 is a diagram showing a second example of a method of providing food ordering services via a visual cashier with artificial intelligence

FIG. 6 is a diagram showing a third example of a method of providing food ordering services via a visual cashier with artificial intelligence

FIG. 7 is a diagram showing a fourth example of a method of providing food ordering services via a visual cashier with artificial intelligence

FIG. 8 is a diagram showing a fifth example of a method of providing food ordering services via a visual cashier with artificial intelligence

### DETAILED DESCRIPTION

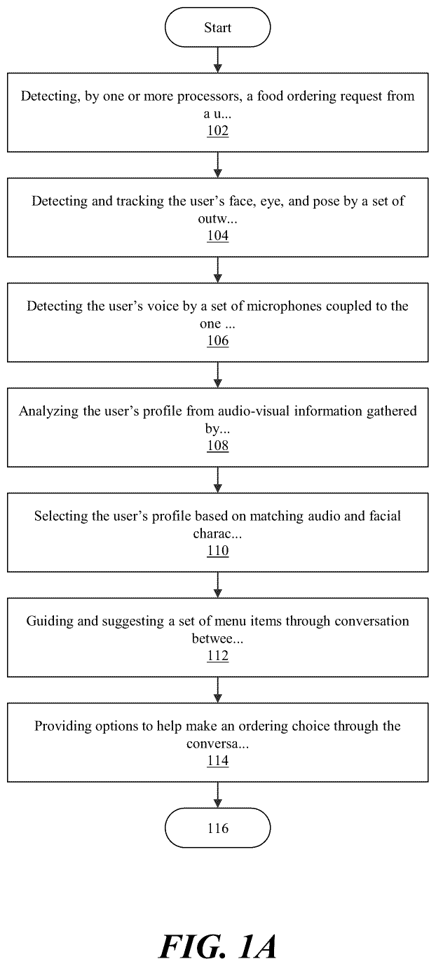

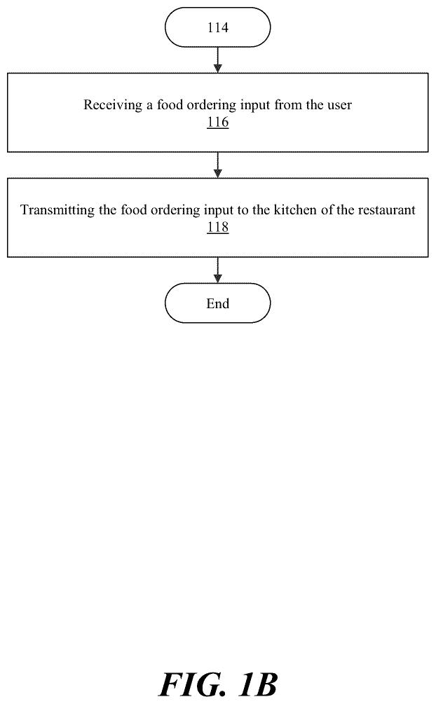

FIGS. 1A to 1B are flowcharts that describe a method for providing food ordering services via a visual cashier with artificial intelligence, according to some embodiments of the present disclosure. In some embodiments, at 102, the method may include detecting, by one or more processors, a food ordering request from a user in the restaurant. At 104, the method may include detecting and tracking the user's face, eye, and pose by a set of outward-facing cameras coupled to the one or more processors. At 106, the method may include detecting the user's voice by a set of microphones coupled to the one or more processors.

In some embodiments, at 108, the method may include analyzing the user's profile from audio-visual information gathered by the set of outward-facing cameras and the set of microphones. At 110, the method may include selecting the user's profile based on matching audio and facial characteristics from a set of profiles in a customer database on the server. At 112, the method may include guiding and suggesting a set of menu items through conversation between the virtual cashier and the user. At 114, the method may include providing options to help make an ordering choice through the conversation. At 116, the method may include receiving a food ordering input from the user. At 118, the method may include transmitting the food ordering input to the kitchen of the restaurant.

In some embodiments, an artificial intelligence engine may be coupled to the one or more processors and a server. The artificial intelligence engine may be trained by human experts in the field. The virtual cashier may be configured to be displayed in LED/OLED displays, Android/iOS tablets, Laptops/PCs, or smartphones, or VR/AR goggles. A set of multi-layer info panels coupled to the one or more processors may be configured to overlay graphics on top of the virtual cashier.

In some embodiments, the virtual cashier may be configured to be displayed with an appearance of a real human or a humanoid or a cartoon character. The virtual cashier's gender, age and ethnicity may be determined by the artificial Intelligence's analysis on input from the user. The virtual cashier may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The one or more processors may put the user in a waiting list if the restaurant may be full and will notify the user when the table may be ready and will estimate waiting time and communicate with customers. A set of touch screens coupled to the one or more processors may be configured to allow the user to interact with the virtual cashier by hand.

In some embodiments, the set of microphones may be connected to loudspeakers. The set of microphones may be enabled to be beamforming. Pictures or voices of the user may be configured to be uploaded and processed either on a cloud server or in local or personal devices to analyze and create the virtual cashier. The virtual cashier may be configured to be created based on the appearance of a real human character, a popular cartoon character.

In some embodiments, the virtual cashier may be related to a personality shown in the advertisement of the restaurant. The user's profile may include the user's audio and facial characteristics. The user's profile may comprise information on prior food ordering habits, food preferences, and possible food allergies. The conversation may be based on the user's profile and analysis of the artificial intelligence engine. The food ordering input comprises any food special requests from the user. In some embodiments, the food special requests may include the preferred degree of sweetness of the drink. In some embodiments, the food ordering input may be incorporated into the user's profile by the artificial intelligence engine.

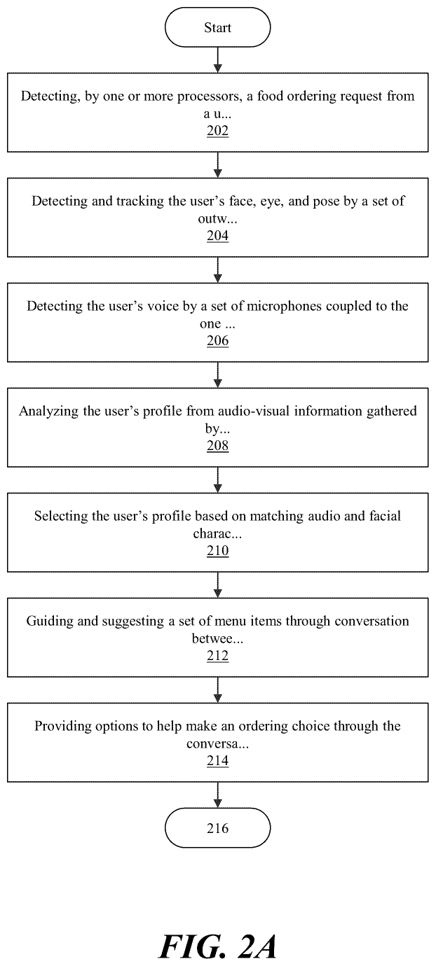

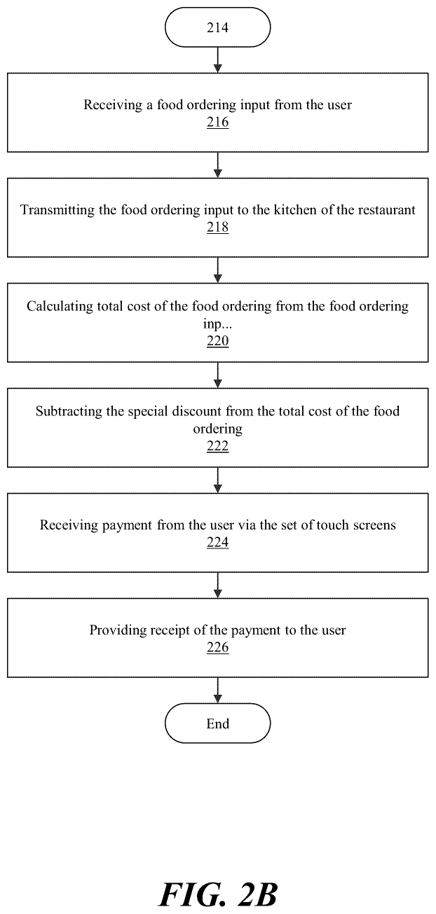

FIGS. 2A to 2B are flowcharts that describe a method for providing food ordering services via a visual cashier with artificial intelligence, according to some embodiments of the present disclosure. In some embodiments, at 202, the method may include detecting, by one or more processors, a food ordering request from a user in the restaurant. At 204, the method may include detecting and tracking the user's face, eye, and pose by a set of outward-facing cameras coupled to the one or more processors. At 206, the method may include detecting the user's voice by a set of microphones coupled to the one or more processors.

In some embodiments, at 208, the method may include analyzing the user's profile from audio-visual information gathered by the set of outward-facing cameras and the set of microphones. At 210, the method may include selecting the user's profile based on matching audio and facial characteristics from a set of profiles in a customer database on the server. At 212, the method may include guiding and suggesting a set of menu items through conversation between the virtual cashier and the user.

In some embodiments, at 214, the method may include providing options to help make an ordering choice through the conversation. At 216, the method may include receiving a food ordering input from the user. At 218, the method may include transmitting the food ordering input to the kitchen of the restaurant. At 220, the method may include calculating total cost of the food ordering from the food ordering input from the user. At 222, the method may include subtracting the special discount from the total cost of the food ordering. At 224, the method may include receiving payment from the user via the set of touch screens. At 226, the method may include providing receipt of the payment to the user.

In some embodiments, an artificial intelligence engine may be coupled to the one or more processors and a server. The artificial intelligence engine may be trained by human experts in the field. The virtual cashier may be configured to be displayed in LED/OLED displays, Android/iOS tablets, Laptops/PCs, or smartphones, or VR/AR goggles. A set of multi-layer info panels coupled to the one or more processors may be configured to overlay graphics on top of the virtual cashier.

In some embodiments, the virtual cashier may be configured to be displayed with an appearance of a real human or a humanoid or a cartoon character. The virtual cashier's gender, age and ethnicity may be determined by the artificial Intelligence's analysis on input from the user. The virtual cashier may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. A set of touch screens coupled to the one or more processors may be configured to allow the user to interact with the virtual cashier by hand. The set of microphones may be connected to loudspeakers. The set of microphones may be enabled to be beamforming. Pictures or voices of the user may be configured to be uploaded and processed either on a cloud server or in local or personal devices to analyze and create the virtual cashier.

In some embodiments, the virtual cashier may be configured to be created based on the appearance of a real human character, a popular cartoon character. The virtual cashier may be related to a personality shown in the advertisement of the restaurant. The user's profile may include the user's audio and facial characteristics. The user's profile may comprise information on prior food ordering habits, food preferences, and possible food allergies.

In some embodiments, the conversation may be based on the user's profile and analysis of the artificial intelligence engine. The food ordering input comprises any food special requests from the user. The user can choose payment methods for the payment. The artificial intelligence engine may be configured to use face recognition, and other personal identification means for payment. The artificial intelligence engine may be also configured to identify the user through question and answer. In some embodiments, the food special requests may include the preferred degree of sweetness of the drink. In some embodiments, the food ordering input may be incorporated into the user's profile by the artificial intelligence engine.

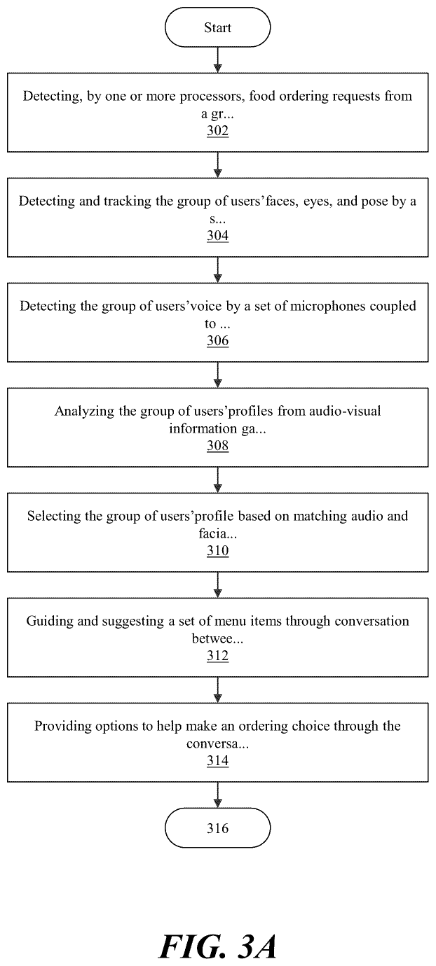

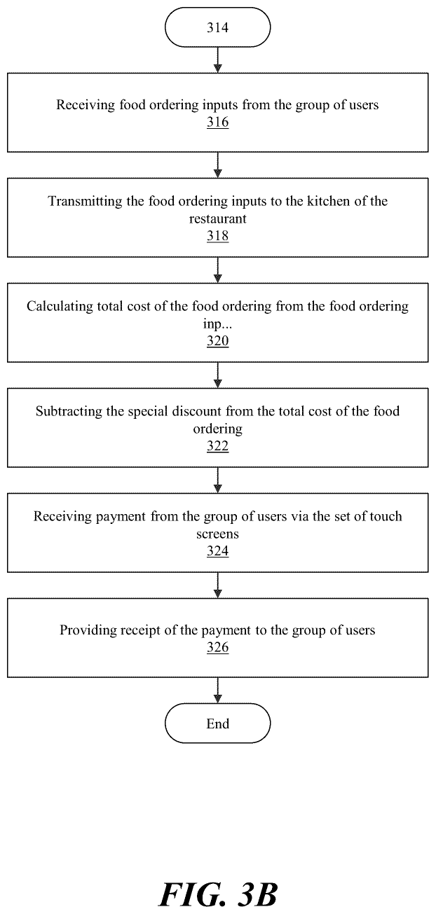

FIGS. 3A to 3B are flowcharts that describe a method for providing food ordering services via a visual cashier with artificial intelligence, according to some embodiments of the present disclosure. In some embodiments, at 302, the method may include detecting, by one or more processors, food ordering requests from a group of users in the restaurant. At 304, the method may include detecting and tracking the group of users'faces, eyes, and pose by a set of outward-facing cameras coupled to the one or more processors. At 306, the method may include detecting the group of users'voice by a set of microphones coupled to the one or more processors.

In some embodiments, at 308, the method may include analyzing the group of users'profiles from audio-visual information gathered by the set of outward-facing cameras and the set of microphones. At 310, the method may include selecting the group of users'profile based on matching audio and facial characteristics from a set of profiles in a customer database on the server. At 312, the method may include guiding and suggesting a set of menu items through conversation between the virtual cashier and the group of users.

In some embodiments, at 314, the method may include providing options to help make an ordering choice through the conversation. At 316, the method may include receiving food ordering inputs from the group of users. At 318, the method may include transmitting the food ordering inputs to the kitchen of the restaurant. At 320, the method may include calculating total cost of the food ordering from the food ordering input from the group of users. At 322, the method may include subtracting the special discount from the total cost of the food ordering. At 324, the method may include receiving payment from the group of users via the set of touch screens. At 326, the method may include providing receipt of the payment to the group of users.

In some embodiments, an artificial intelligence engine may be coupled to the one or more processors and a server. The artificial intelligence engine may be trained by human experts in the field. The virtual cashier may be configured to be displayed in LED/OLED displays, Android/iOS tablets, Laptops/PCs, or smartphones, or VR/AR goggles. A set of multi-layer info panels coupled to the one or more processors may be configured to overlay graphics on top of the virtual cashier.

In some embodiments, the virtual cashier may be configured to be displayed with an appearance of a real human or a humanoid or a cartoon character. The virtual cashier's gender, age and ethnicity may be determined by the artificial Intelligence's analysis on input from the group of users. The virtual cashier may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. A set of touch screens coupled to the one or more processors may be configured to allow the group of users to interact with the virtual cashier by hand. The set of microphones may be connected to loudspeakers. The set of microphones may be enabled to be beamforming. Pictures or voices of the group of users may be configured to be uploaded and processed either on a cloud server or in local or personal devices to analyze and create the virtual cashier.

In some embodiments, the virtual cashier may be configured to be created based on the appearance of a real human character, a popular cartoon character. The virtual cashier may be related to a personality shown in the advertisement of the restaurant. The group of users'profiles may include the group of users'audio and facial characteristics. The group of users'profiles may comprise information on prior food ordering habits, food preferences, and possible food allergies.

In some embodiments, the conversation may be based on the group of users'profile and analysis of the artificial intelligence engine. The artificial intelligence engine may analyze the social settings of the group of users and provide balanced recommendations and suggestions crossing different profiles and personal preference and restrictions. The food ordering input comprises any food special requests from the group of users. The group of users can choose payment methods for the payment. The artificial intelligence engine may be configured to use face recognition, and other personal identification means for payment. The artificial intelligence engine may be also configured to identify the group of users through question and answer.

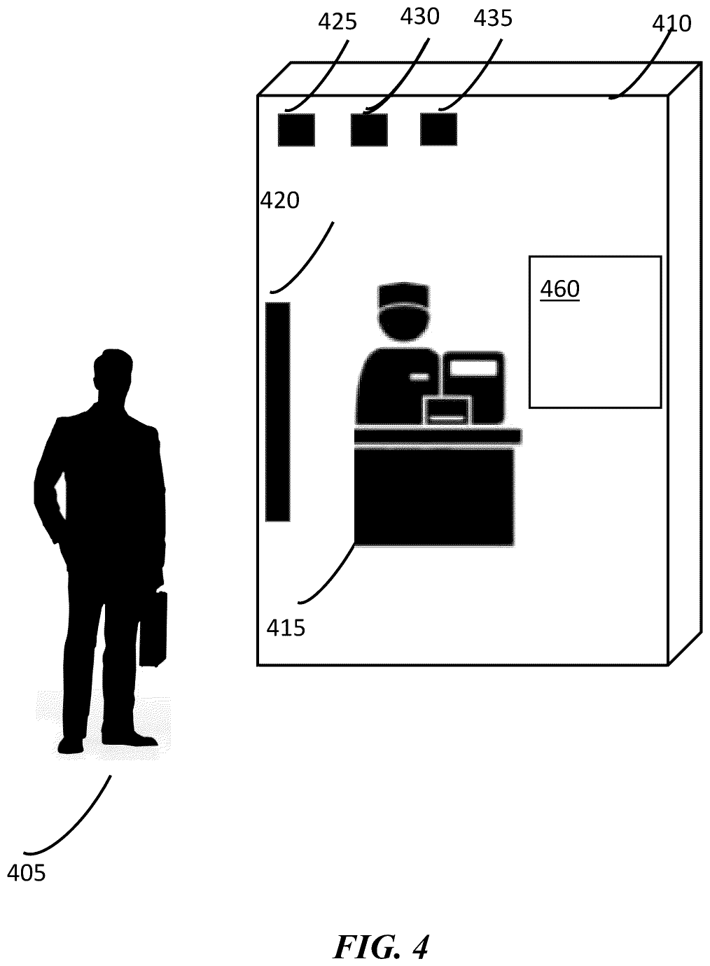

FIG. 4 is a diagram showing an example of a method of providing food ordering services via a visual cashier with artificial intelligence.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual cashier 415 is active on the smart display 410. In some embodiments, a visual menu 460 is shown on the smart display 410. In some embodiments, user 405 can approach the smart display 410 and initiate and complete the food ordering process with the visual cashier 415 by the methods described in FIG. 1A, FIG. 1B, FIG. 2A, FIG. 2B, FIG. 3A and FIG. 3B. In some embodiments, interactive panel 420 is coupled to a central processor. In some embodiments, interactive panel 420 is coupled to a server via a wireless link. In some embodiments, user 405 can interact with the visual cashier 415 via camera 425, sensor 430 and microphone 435 using methods described in FIG. 1A, FIG. 1B, FIG. 2A, FIG. 2B, FIG. 3A and FIG. 3B, with the help of interactive panel 420. In some embodiments, user 405 can choose what language to be used.

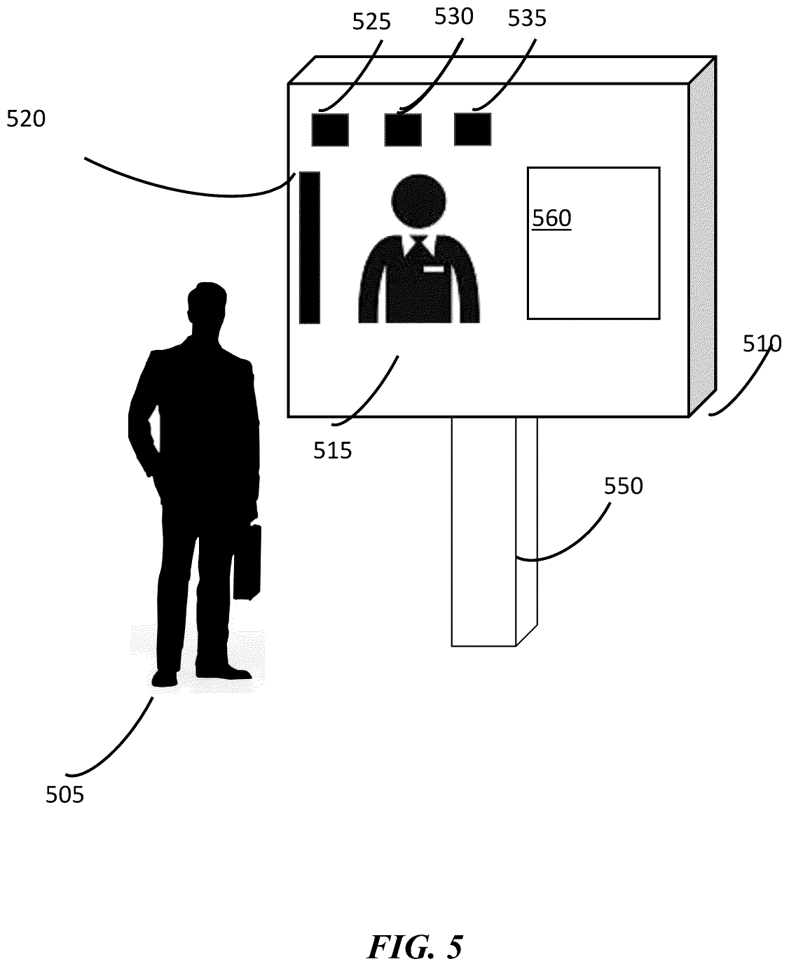

FIG. 5 is a diagram showing a second example of a method of providing food ordering services via a visual cashier with artificial intelligence.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530 and microphone 535 are attached to the smart display 510. In some embodiments, a support column 550 is attached to the smart display 510. In some embodiments, an artificial intelligence visual cashier 515 is active on the smart display 510. In some embodiments, a visual menu 560 is shown on the smart display 510. In some embodiments, user 505 can approach the smart display 510 and initiate and complete the food ordering process with the visual cashier 515 by the methods described in FIG. 1A, FIG. 1B, FIG. 2A, FIG. 2B, FIG. 3A and FIG. 3B. In some embodiments, interactive panel 520 is coupled to a central processor. In some embodiments, interactive panel 520 is coupled to a server via a wireless link. In some embodiments, user 505 can interact with the visual cashier 515 via camera 525, sensor 530 and microphone 535 using methods described in FIG. 1A, FIG. 1B, FIG. 2A, FIG. 2B, FIG. 3A and FIG. 3B, with the help of interactive panel 520. In some embodiments, user 505 can choose what language to be used.

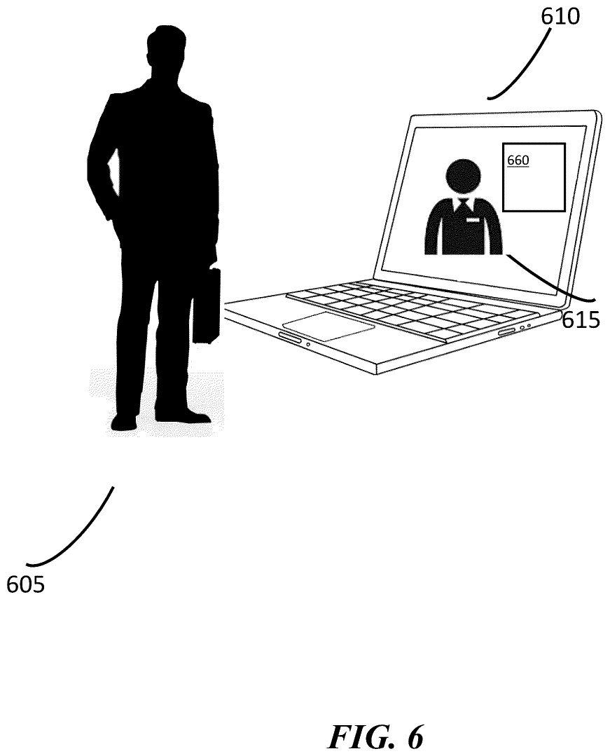

FIG. 6 is a diagram showing a third example of a method of providing food ordering services via a visual cashier with artificial intelligence.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, camera, sensor, and microphone are attached to the smart display 610. In some embodiments, an artificial intelligence visual cashier 615 is active on the smart display 610. In some embodiments, a visual menu 660 is shown on the smart display 610. In some embodiments, user 605 can approach the smart display 610 and initiate and complete the food ordering process with the visual cashier 615 by the methods described in FIG. 1A, FIG. 1B, FIG. 2A, FIG. 2B, FIG. 3A and FIG. 3B. In some embodiments, a keyboard is coupled to a central processor. In some embodiments, a keyboard is coupled to a server via a wireless link. In some embodiments, user 605 can interact with the visual cashier 615 via camera, sensor and microphone using methods described in FIG. 1A, FIG. 1B, FIG. 2A, FIG. 2B, FIG. 3A and FIG. 3B, with the help of the keyboard. In some embodiments, user 605 can choose what language to be used.

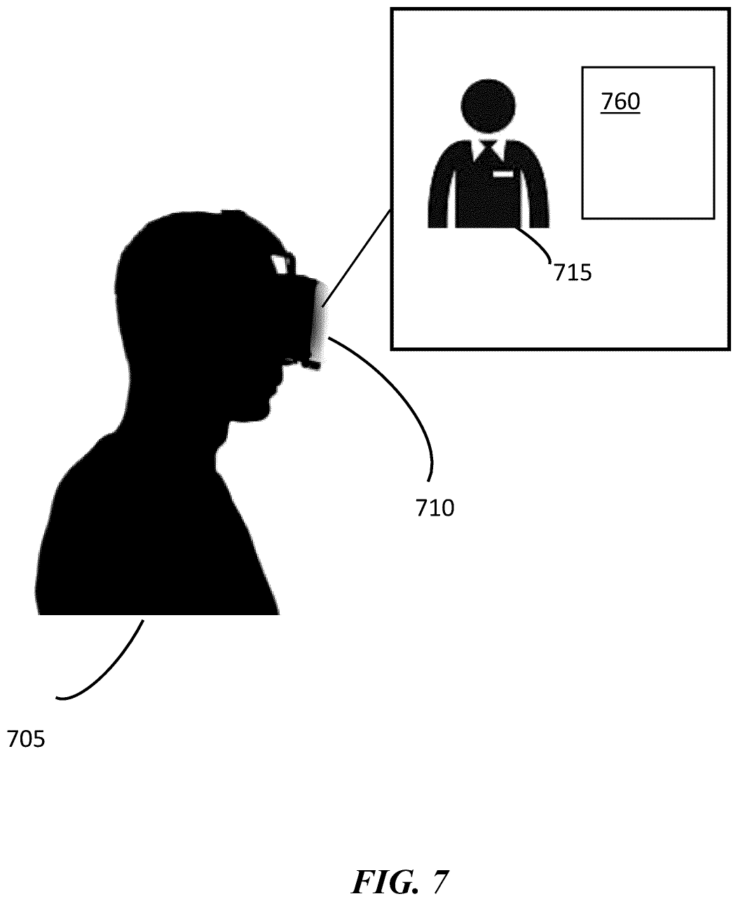

FIG. 7 is a diagram showing a fourth example of a method of providing food ordering services via a visual cashier with artificial intelligence.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual cashier 715 is active on the VR or AR device 710. In some embodiments, a visual menu 760 is shown on the VR or AR 710. In some embodiments, user 705 can initiate and complete the food ordering process with the visual cashier 705 via the VR or AR device 715 by the methods described in FIG. 1A, FIG. 1B, FIG. 2A, FIG. 2B, FIG. 3A and FIG. 3B. In some embodiments, an interactive panel is coupled to a central processor. In some embodiments, an interactive panel is coupled to a server via a wireless link. In some embodiments, the user 705 can choose what language to be used.

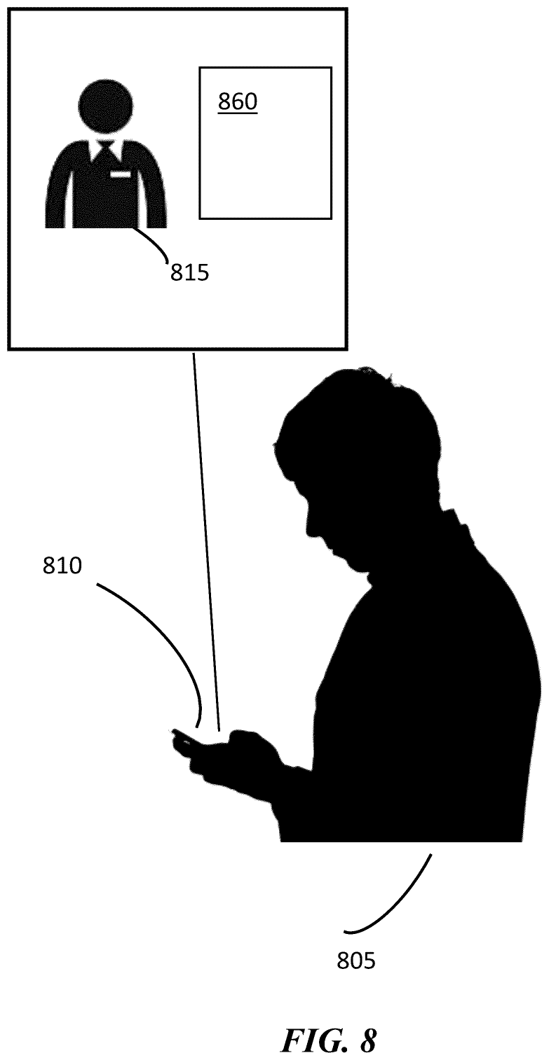

FIG. 8 is a diagram showing a fifth example of a method of providing food ordering services via a visual cashier with artificial intelligence. In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual cashier 815 is active on the smartphone device 810. In some embodiments, a visual menu 860 is shown on the smartphone device 810. In some embodiments, user 805 can initiate and complete the food ordering process with the visual cashier 805 via smartphone device 810 by the methods described in FIG. 1A, FIG. 1B, FIG. 2A, FIG. 2B, FIG. 3A and FIG. 3B. In some embodiments, an interactive panel is coupled to a central processor. In some embodiments, interactive panel is coupled to a server via a wireless link. In some embodiments, the user 805 can choose what language to be used.

1. A method for providing food ordering services via a virtual cashier with artificial intelligence within a restaurant, the method comprising:
detecting, by one or more processors, a food ordering request from a user in the restaurant, wherein an artificial intelligence engine is coupled to the one or more processors and a server, wherein the artificial intelligence engine is trained by human experts in the field, wherein the virtual cashier is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual cashier, wherein the virtual cashier is configured to be displayed with an appearance of a real human or a humanoid or a cartoon character, wherein the virtual cashier's gender, age and ethnicity is determined by the artificial Intelligence's analysis on input from the user, wherein the virtual cashier is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the one or more processors may put the user in a waiting list if the restaurant is full and will notify the user when the table is ready and will estimate waiting time and communicate with customers;
detecting and tracking the user's face, eye, and pose by a set of outward-facing cameras coupled to the one or more processors, wherein a set of touch screens coupled to the one or more processors is configured to allow the user to interact with the virtual cashier by hand;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual cashier, wherein the virtual cashier is configured to be created based on the appearance of a real human character, a popular cartoon character, wherein the virtual cashier is related to a personality shown in the advertisement of the restaurant;
analyzing the user's profile from audio-visual information gathered by the set of outward-facing cameras and the set of microphones, wherein the user's profile includes the user's audio and facial characteristics;
selecting the user's profile based on matching audio and facial characteristics from a set of profiles in a customer database on the server, wherein the user's profile comprises information on prior food ordering habits, food preferences, and possible food allergies;
guiding and suggesting a set of menu items through conversation between the virtual cashier and the user, wherein the conversation is based on the user's profile and analysis of the artificial intelligence engine;
providing options to help make an ordering choice through the conversation;
receiving a food ordering input from the user, wherein the food ordering input comprises any food special requests from the user; and
transmitting the food ordering input to the kitchen of the restaurant.

2. A method for providing food ordering services via a virtual cashier with artificial intelligence within a restaurant in claim 1, wherein the food special requests include the preferred degree of sweetness of the drink.

3. A method for providing food ordering services via a virtual cashier with artificial intelligence within a restaurant in claim 1, wherein the food ordering input is incorporated into the user's profile by the artificial intelligence engine.

4. A method for providing food ordering services via a virtual cashier with artificial intelligence within a restaurant, the method comprising:
detecting, by one or more processors, a food ordering request from a user in the restaurant, wherein an artificial intelligence engine is coupled to the one or more processors and a server, wherein the artificial intelligence engine is trained by human experts in the field, wherein the virtual cashier is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual cashier, wherein the virtual cashier is configured to be displayed with an appearance of a real human or a humanoid or a cartoon character, wherein the virtual cashier's gender, age and ethnicity is determined by the artificial Intelligence's analysis on input from the user; wherein the virtual cashier is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
detecting and tracking the user's face, eye, and pose by a set of outward-facing cameras coupled to the one or more processors, wherein a set of touch screens coupled to the one or more processors is configured to allow the user to interact with the virtual cashier by hand;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual cashier, wherein the virtual cashier is configured to be created based on the appearance of a real human character, a popular cartoon character, wherein the virtual cashier is related to a personality shown in the advertisement of the restaurant;
analyzing the user's profile from audio-visual information gathered by the set of outward-facing cameras and the set of microphones, wherein the user's profile includes the user's audio and facial characteristics;
selecting the user's profile based on matching audio and facial characteristics from a set of profiles in a customer database on the server, wherein the user's profile comprises information on prior food ordering habits, food preferences, and possible food allergies;
guiding and suggesting a set of menu items through conversation between the virtual cashier and the user, wherein the conversation is based on the user's profile and analysis of the artificial intelligence engine;
providing options to help make an ordering choice through the conversation;
receiving a food ordering input from the user, wherein the food ordering input comprises any food special requests from the user; and
transmitting the food ordering input to the kitchen of the restaurant.
calculating total cost of the food ordering from the food ordering input from the user;
subtracting the special discount from the total cost of the food ordering;
receiving payment from the user via the set of touch screens, wherein the user can choose payment methods for the payment, wherein the artificial intelligence engine is configured to use face recognition, and other personal identification means for payment, wherein the artificial intelligence engine is also configured to identify the user through question and answer; and
providing receipt of the payment to the user.

5. A method for providing food ordering and payment services via a virtual cashier with artificial intelligence within a restaurant in claim 4, wherein the food special requests include the preferred degree of sweetness of the drink.

6. A method for providing food ordering and payment services via a virtual cashier with artificial intelligence within a restaurant in claim 4, wherein the food ordering input is incorporated into the user's profile by the artificial intelligence engine.

7. A method for providing food ordering services via a virtual cashier with artificial intelligence within a restaurant, the method comprising:
detecting, by one or more processors, food ordering requests from a group of users in the restaurant, wherein an artificial intelligence engine is coupled to the one or more processors and a server, wherein the artificial intelligence engine is trained by human experts in the field, wherein the virtual cashier is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual cashier, wherein the virtual cashier is configured to be displayed with an appearance of a real human or a humanoid or a cartoon character, wherein the virtual cashier's gender, age and ethnicity is determined by the artificial Intelligence's analysis on input from the group of users; wherein the virtual cashier is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
detecting and tracking the group of users' faces, eyes, and pose by a set of outward-facing cameras coupled to the one or more processors, wherein a set of touch screens coupled to the one or more processors is configured to allow the group of users to interact with the virtual cashier by hand;
detecting the group of users' voice by a set of microphones coupled to the one or more processors, wherein the set of microphones are connected to loudspeakers, wherein the set of microphones are enabled to be beamforming, wherein pictures or voices of the group of users are configured to be uploaded and processed either on a cloud server or in local or personal devices to analyze and create the virtual cashier, wherein the virtual cashier is configured to be created based on the appearance of a real human character, a popular cartoon character, wherein the virtual cashier is related to a personality shown in the advertisement of the restaurant;
analyzing the group of users' profiles from audio-visual information gathered by the set of outward-facing cameras and the set of microphones, wherein the group of users' profiles includes the group of users' audio and facial characteristics;
selecting the group of users' profile based on matching audio and facial characteristics from a set of profiles in a customer database on the server, wherein the group of users' profiles comprises information on prior food ordering habits, food preferences, and possible food allergies;
guiding and suggesting a set of menu items through conversation between the virtual cashier and the group of users, wherein the conversation is based on the group of users' profile and analysis of the artificial intelligence engine, wherein the artificial intelligence engine may analyze the social settings of the group of users and provide balanced recommendations and suggestions crossing different profiles and personal preference and restrictions.
providing options to help make an ordering choice through the conversation;
receiving food ordering inputs from the group of users, wherein the food ordering input comprises any food special requests from the group of users; and
transmitting the food ordering inputs to the kitchen of the restaurant.
calculating total cost of the food ordering from the food ordering input from the group of users;
subtracting the special discount from the total cost of the food ordering;
receiving payment from the group of users via the set of touch screens, wherein the group of users can choose payment methods for the payment, wherein the artificial intelligence engine is configured to use face recognition, and other personal identification means for payment, wherein the artificial intelligence engine is also configured to identify the group of users through question and answer; and
providing receipt of the payment to the group of users.
